(19) United States
(12) Patent Application Publication
(10) Pub. No.: US 2012/0203150 A1
(43) Pub. Date: Aug. 9, 2012

(54) Foot Massage Ottoman

(76) Inventor: Mark J. Eberhardt, Kenosha, WI (US)

(21) Appl. No.: 13/367,175

(22) Filed: Feb. 6, 2012

Related U.S. Application Data
(60) Provisional application No. 61/440,974, filed on Feb. 9, 2011.

(51) Int. Cl. A61H 1/00

(52) U.S. Cl. 601/55; 601/49

(57) ABSTRACT

An ottoman holds a foot massage unit accessible through an opening in the ottoman to permit dual use of the ottoman as a footrest and foot massage without substantial repositioning.

### CROSS-REFERENCE TO RELATED APPLICATIONS

This application claims the benefit of U.S. provisional application 61/440,974 filed Feb. 9, 2011 and hereby incorporated by reference.

### FIELD OF THE INVENTION

The present invention relates to foot massage equipment and in particular to a foot massage unit incorporated into an ottoman.

### BACKGROUND OF THE INVENTION

Travelers staying in hotels are often in environments where they are called upon to walk or stand for greater amounts of time than that to which they are accustomed, for example, as is the case with vacationers sightseeing on foot or business persons attending trade shows.

It is known in the art to place foot massage machines in areas frequented by travelers. Such machines include a horizontal platform vibrated by electric motor or the like supported on a base that may be set near the ground. The base may be attached in front of an elevated seat allowing a seated user to position his or her feet correctly on the vibrating platform. A foot massage unit of this type is commercially available from Footsie Wootsie of Orlando Fla. and includes coin acceptors controlling timers delivering a predetermined foot massage time.

Desirably, travelers would have access to such foot massage equipment at the end of the day upon return to their hotel rooms. Conventional foot massage chair units, however, are unduly bulky and hence impractical in a hotel room where space is at a premium.

### SUMMARY OF THE INVENTION

The present invention provides a foot massage unit positioned within the otherwise empty internal space of an ottoman. The height of the ottoman and the position and angulation of the vibrating plate of a foot massage unit are selected so that the user's feet may be placed on either the vibrating plate of the ottoman or upon the top of the ottoman without substantially repositioning the ottoman with respect to a nearby chair. In this way in the foot massage may be readily integrated into standard hotel furniture settings.

Specifically, the present invention provides an ottoman unit having a base supported against the floor and a cushioned upper surface supported by the base above the floor to permit resting of the legs or feet of a seated individual thereupon with the legs extended substantially horizontally. A foot massage unit having a vibrating platform is supported on the base beneath the cushioned upper surface to receive the feet of the seated individual thereupon through an open face in the ottoman. The vibrating platform of the foot massage unit is angled to slope upward as one moves away from the seated individual to receive the feet of the seated individual with lower portions of the legs of the individual extending downward through the open face.

It is thus a feature of at least one embodiment of the invention to provide an unobtrusive foot massage unit that may be positioned to function either as a foot rest or foot massage unit. By providing an opening in the ottoman into which the feet may be inserted and, by proper angulation and positioning of the massage unit, the ottoman may provide dual use without substantial modification and with standard chairs. The internal foot massage unit remains inconspicuous, even during use, visible only from the direction of the seat in front of which it is positioned.

The angle of the vibrating platform may be substantially 45 degrees.

It is thus a feature of at least one embodiment of the invention to allow proper positioning of the feet against the vibrating platform from a seated position on the nearby chair that is also close enough for the seated individual to use the top of the ottoman as a foot rest.

The vibrating platform may be free from projecting structure that would interfere with flexure of a person's ankle when the person's foot is placed against the vibrating plate.

It is thus a feature of at least one embodiment of the invention to permit the massage unit also function as a back massage. In this regard the top of the ottoman may be removable.

The base may provide a base plate spaced from a supporting floor surface by legs.

It is thus a feature of at least one embodiment of the invention to reduce downward sound transmission of the massage unit when used in a hotel or the like.

The base plate may include apertures for air circulation therethrough.

It is thus a feature of at least one embodiment of the invention to permit a broad area vibrating platform actually filling the open side of the ottoman while allowing sufficient air circulation to the motor portions.

The ottoman may further include further an air permeable material positioned between foot massage unit and the apertures.

It is thus a feature of at least one embodiment of the invention provide filtration and or acoustic damping of the air passing through the apertures.

The ottoman unit may have an outer surface that is substantially a rectangular prism.

It is thus a feature of at least one embodiment of the invention to provide a simple shape that is readily manufactured and which provides a reduced angle of visibility of the opening.

The open face maybe flanked by at least one vertical wall facing the seated individual and support a timer unit for controlling power to the foot massage unit to a predetermined duration, the timer unit presenting a timer control facing the seated user.

It is thus a feature of at least one embodiment of the invention to permit time control of the foot massage accessible to the seated individual.

The foot massage ottoman may further include a wireless credit card reader connected to the timer for providing power to the foot massage unit only after a predetermined payment.

It is thus a feature of at least one embodiment of the invention to provide a mechanism for recapturing the costs of providing a massage unit in a hotel environment.

The base may include sound absorbing material positioned between the base and the foot massage unit.

It is thus a feature of at least one embodiment of the invention to reduce the radiated sound from a foot massage unit to allow the unit to be used in a multi-occupancy building.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of the foot massage ottoman of the present invention showing an opening through which a user's feet may be inserted to contact a vibrating platform of a massage unit;

FIG. 2 is a top plan cross-section of the ottoman of FIG. 1 showing positioning of the foot massage unit between baffle walls for sound reduction and showing the location of a manual timer unit;

FIG. 3 is a fragmentary detail of a lower corner of FIG. 2 showing an alternative embodiment having a credit card reader and a timing unit;

FIG. 4 is a side elevational view in cross-section of the foot massage unit of FIG. 1 showing its dual use as a leg support and foot massage unit without repositioning;

FIG. 5 is a figure similar to that of FIG. 4 showing use of the foot massage unit for back massage.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE PREFERRED EMBODIMENTS

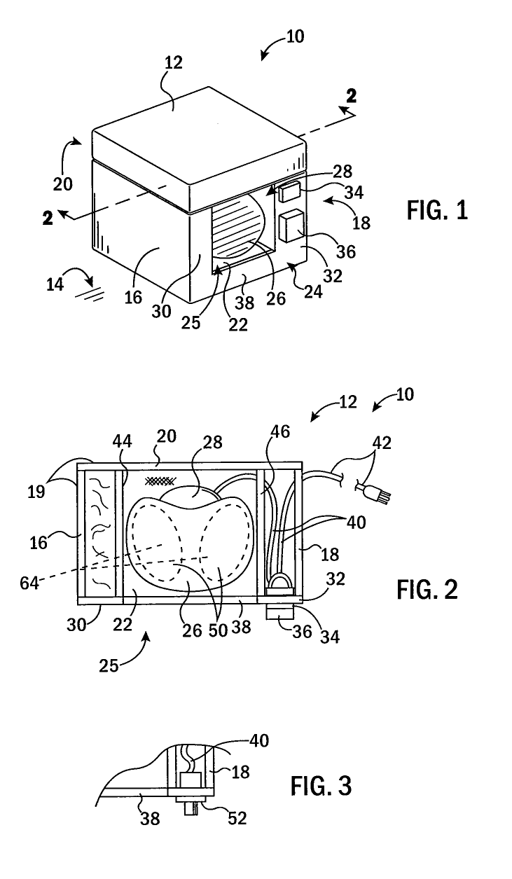

Referring now to FIGS. 1 and 3, an ottoman 10 of the present invention may provide a generally rectangular horizontal upper cushion 12, for example, being a substantially square rigid panel 15, such as plywood, topped with a polyurethane foam 17, the latter upholstered to the panel 15 with an upholstery material 19. The upholstery material 19 may be a flame retardant leather like material (e.g. vinyl coated fabric) or fire resistant fabric. An example top cushion may be approximately 20 inches by 20 inches and three inches high.

Referring to FIGS. 1 and 2, the top of the upper cushion 12 may be supported approximately 20 inches above the floor 14 by upstanding left and right sidewalls 16 and 18 and rear wall 20 each attached at their upper edges to a lower edge of the upper cushion 12 and at their lower edges to a base plate 22. The ottoman 10 may provide for a height of 19 to 21 inches in one embodiment with a length from 24 to 26 inches in width of about 20 inches.

The base plate 22 may be supported away from the floor by bun legs 21 positioned at the four corners of the base plate 22.

A front face 24 of the ottoman 10 provides an opening 25 to expose therethrough a vibrating platform or footplate 26 of a massage unit 28 positioned beneath the upper cushion 12 in the cavity defined by the upper cushion 12, the base plate 22, the left and right sidewalls 16 and 18 and the rear wall 20. The massage unit 28 may, for example, include an electric motor having a cam or crank and arm acting on the footplate 26 for vibrating the same, or may provide an eccentric weight attached to and vibrating a spring mounted footplate 26. In one embodiment the footplate 26 provides a surface of about one square foot in area and a width of about 12 inches and height of about 12 inches bifurcated into two areas roughly corresponding to the shape of two feet. The footplate 26 may be spaced approximately 1 inch above the base plate 22 and may slope backward at about 45 degrees into the interior of the ottoman 10 as one moves up the footplate 26. The massage unit 28 may provide for whole body type vibrations having a fundamental frequency of approximately 1840 hertz. The body of the massage unit 28 may be bolted to the base plate 22 prevent movement along the base plate and may be serviced by removal of the base plate 22 downward from the remainder of the ottoman 10 for example by releasing a set of screws retaining the base plate 22 to the rest of the ottoman 10.

The opening 25 may be flanked by left and right partial front walls 30 and 32 extending between the base plate 22 and the upper cushion 12 and attached along their outer vertical edges to corresponding edges of the left and right sidewalls 16 and 18. The left and right sidewalls 16 and 18, rear wall 20, base plate 22 and left and right partial front walls 30 and 32 may be panels of plywood or particleboard similar to that of panel 15. The left and right sidewalls 16 and 18, rear wall 20, and left and right partial front walls 30 and 32 may also be upholstered with the upholstery material 19.

A lower edge of the left and right front wall 30 and 32 may be bridged by a retention ledge 38, for example a metal strip providing a finished appearance to the opening 25 and a lip retaining the massage unit 28.

The right sidewall 18 may expose on its front face a display of a timer 34 indicating elapsed time and a wireless credit card reader 36. Wiring 40 may connect the timer 34 and wireless credit card reader 36 to a line cord 42 receiving power from a wall socket or the like. The timer 34 and wireless credit card reader 36 may control the application of power to the massage unit 28 according to whether a credit card payment has been properly authorized and time remains of a predetermined purchased time increment on the timer 34. Generally upon receiving a valid credit card number transmitted from the wireless credit card reader 36, a predetermined time will be placed in the timer 34 and the massage unit 28 will operate until that predetermined time has elapsed. The wireless credit card reader 36 may be, for example, an ePort cashless payment system from USA Technologies Inc. of Malvern, Pa., USA providing wireless credit card authorization and charging.

The wiring 40 may be contained behind false left and right sidewalls 44 and 46 being generally parallel to left and right sidewalls 16 and 18 but displaced inward proximate to the left and right sides of the footplate 26 of the foot massage unit 28. The space between the false left and right sidewalls 44 and 46 and the left and right sidewalls 16 and 18 may also be filled with sound absorbing material (not shown for clarity).

Referring to FIG. 2, the vibrating footplate 26 may provide for a surface 50 suitable for supporting a person's left and right feet thereupon through the opening 25. The upper surface of the base plate 22 may be carpeted over a carpet pad to further reduce vibration transmitted from the massage unit 28 or may have a thin layer of upholstery fabric.

Referring now to FIG. 3, in an alternative embodiment, the timer 34 and wireless credit card reader 36 may be replaced with a manual timer 52 for home use where charges are not required.

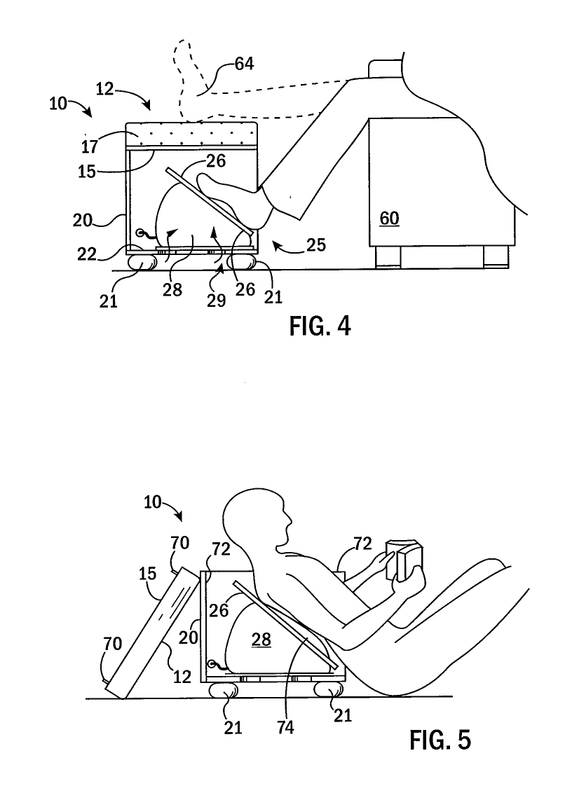

Referring now to FIG. 4, the ottoman 10 may be placed in a single location in front of a chair 60 in a hotel room or the like holding a seated user to rest his or her legs or feet 64 on the upper cushion 12 so that user's legs are substantially horizontal at a slight downward angle. By raising his or her feet, the user may place his or her feet into the opening 25 of the ottoman 10 to be supported on the footplate 26. The vibrating footplate 26 may be free from front facing projections to allow ready accommodation of different ankle angles by the user. The footplate 26 may be angled to slope upward away from the seated user to provide a proper angle of support for the user's feet at the approximate ankle angle experienced when standing comfortably. The base plate may include several openings 29 (for example, two inch openings) to promote air circulation on the motor side of the vibrating footplate 26, the latter which substantially fills the open side of the ottoman 10. The upper side of the base plate 22 may be covered in a black laminate for aesthetic and cleaning purposes.

The ability to use the ottoman 10 in either manner (as a conventional foot rest or as a massage unit) without substantial repositioning allows the ottoman 10 to be built in a robust manner and with sufficient weight to not unduly shift or creep when experiencing pressure from the user's feet. By allowing freedom to flex one's ankle with respect to the vibrating footplate 26 without encumbering structure, different legs of length and separation between the ottoman 10 and the chair 60 may be accommodated. It will be appreciated that the orientation with respect to the chair 60 makes the footplate 26 relatively inconspicuous, being viewable only from angles encompassing the chair 60 that are visually, at least in part, blocked by the chair 60. In this way, the ottoman 10 appears to be standard furniture that blends with the furnishings of the room.

Referring now to FIG. 5, the upper cushion 12 and panel 15 may be removed from the ottoman 10 as supported and aligned thereon by inter-engaging pins 70 and corresponding socket 72 in the upper edge of the upstanding sidewalls 18 and rear wall 20. In this configuration, the user may lie with his or her back against the vibration footplate 26 possibly including a thin cushion 74 to obtain a back massage with their head extending through the area normally occupied by the cushion 12 and their legs resting on the floor extending away from the ottoman 10. The freedom of the vibrating footplate 26 from outwardly projecting surfaces for constraining the lower leg permits such dual use.

Certain terminology is used herein for purposes of reference only, and thus is not intended to be limiting. For example, terms such as “upper”, “lower”, “above”, and “below” refer to directions in the drawings to which reference is made. Terms such as “left”, “right”, “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence, or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

Various features of the invention are set forth in the following claims. It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A foot massage ottoman comprising:
an ottoman unit having a base supportable by a floor and a cushioned upper surface supported by the base above the floor to permit resting of legs or feet of a seated individual thereupon with the legs extended substantially horizontally;
a foot massage unit having a vibrating platform supported on the base beneath the cushioned upper surface to receive the feet of the seated individual thereupon through an open face in the ottoman, wherein the vibrating platform of the foot massage unit is angled to slope upward as one moves away from the seated individual to receive the feet of the seated individual with lower portions of the legs of the seated individual extending downward through the open face.

2. The foot massage ottoman of claim 1 wherein the angle of the vibrating platform is substantially 45 degrees.

3. The foot massage ottoman of claim 2 wherein the vibrating platform is free from projecting structure that would interfere with flexure of a person's ankle when the person's foot is placed against the vibrating plate.

4. The foot massage ottoman of claim 1 wherein the base provides a base plate spaced from a supporting floor surface by legs.

5. The foot massage ottoman of claim 4 wherein the base plate includes apertures for air circulation therethrough

6. The foot massage ottoman of claim 5 further including an air permeable material positioned between foot massage unit and the apertures.

7. The foot massage ottoman of claim 1 wherein the base includes sound absorbing material position between the base and the foot massage unit.

8. The foot massage ottoman of claim 1 wherein the ottoman unit has an outer surface that is substantially five sides of a rectangular prism and wherein the open face is remaining sixth face of the rectangular prism.

9. The foot massage ottoman of claim 8 wherein the open face is flanked by a least one vertical wall facing the seated individual and supporting a timer unit for controlling power to the foot massage unit to a predetermined time, the timer unit presenting a timer control facing the seated user.

10. The foot massage ottoman of claim 9 further including a wireless credit card reader connected to the timer for providing power to the foot massage unit only after a predetermined payment.

11. The foot massage ottoman of claim 1 wherein the cushioned top is releasably removable to allow an individual to rest his or her back against the vibrating platform when positioned within the ottoman unit.
